(19) United States
(12) Patent Application Publication
(10) Pub. No.: US 2023/0076893 A1
(43) Pub. Date: Mar. 9, 2023

(54) COMPLEMENTARY LEARNING SYSTEM BASED EXPERIENCE REPLAY (CLS-ER)

(71) Applicant: NavInfo Europe B.V., Eindhoven (NL)

(72) Inventors: Elahe ARANI, Eindhoven (NL); Fahad SARFRAZ, Eindhoven (NL); Bahram ZONOOZ, Eindhoven (NL)

(73) Assignee: NavInfo Europe B.V., Eindhoven (NL)

(21) Appl. No.: 17/469,474

(22) Filed: Sep. 8, 2021

(51) Int. Cl. G06K 9/62; G06N 20/00

(52) U.S. Cl. CPC G06K 9/6257; G06K 9/6262; G06N 20/00

(57) ABSTRACT

Embodiments of the disclosure provide methods and systems for an artificial intelligence method of making predictions from a sequence of images. The method may include receiving the sequence of images acquired at different time points. The method may further include applying a stable model to process the sequence of images to make the predictions. The stable model is trained along with a working model and a plastic model. The training enforces a consistency among the working model, the stable model, and the plastic model. The working model is trained using a loss function including a cross-entropy loss on a union of a training batch and memory exemplars and a consistency loss on the memory exemplars.

### TECHNICAL FIELD

The present disclosure relates to methods and systems for making predictions from a sequence of images, using trained models. The present disclosure also relates to methods and systems for training such prediction models. More specifically, the present disclosure relates to an artificial intelligence learning models trained with a stable model and plastic model used to make the predictions. The model may be applied for computer vision applications. The present disclosure also pertains to continually acquiring and consolidating knowledge from a stream of non-stationary data.

### BACKGROUND

Dynamic image processing techniques are widely used in applications such as autonomous driving, surveillance, medical imaging, etc. Dynamic image data essentially include a sequence of images acquired at different time points that capture a dynamic environment. Machine learning methods, such as deep neural networks (DNN), have been developed in the computer vision area to process images, such as stationary images and make intelligent predictions based thereon. However, most DNN methods do not take full advantage of knowledge gained through processing the previous image frames, leading to the use of continual learning methods.

Humans excel at continually learning from an ever-changing environment and accumulating and consolidating knowledge, which remains a challenge for DNN. Continual learning (CL) refers to the ability of a learning agent to continuously interact with a dynamic environment and process a stream of information to acquire new knowledge while consolidating and retaining previously acquired knowledge.

A major challenge towards enabling continual learning in DNNs is that the continual acquisition of incrementally available information from non-stationary data distributions generally leads to catastrophic forgetting or interference whereby the performance of the model on previously learned tasks drops drastically as it learns new tasks. Continual learning methods aim to address this issue of catastrophic forgetting in DNNs and enable efficient continuous learning.

Several approaches have been proposed to address the issue of catastrophic forgetting in CL. These can be broadly categorized into regularization-based methods that penalize changes in the network weights, network expansion-based methods that dedicate a distinct set of network parameters to distinct tasks, and rehearsal-based methods that maintain a memory buffer and replay samples from previous tasks. Amongst these, rehearsal-based methods have proven to be more effective in challenging CL tasks. In particular, a current experience replay method, Dark Experience Replay (DER) saves the network response during the entire optimization trajectory and adds a consistency loss on top of Experience Replay (ER). However, an optimal approach for replaying memory samples and constraining the model update to efficiently accumulate knowledge remains an open question.

To address these and other problems of existing DNN methods, the present disclosure provides improved methods and systems that train and use artificial intelligence inference models that can take advantage of the interplay between rapid instance-based learning and slow structured learning.

### SUMMARY

Novel methods and systems of a complementary learning system based experience replay (CLS-ER) approach are disclosed.

In one aspect, embodiments of the disclosure provide an artificial intelligence method of making predictions from a sequence of images. The method may include receiving the sequence of images acquired at different time points. The method may further include applying a stable model to process the sequence of images to make the predictions. The stable model is trained along with a working model and a plastic model. The training enforces a consistency among the working model, the stable model, and the plastic model. The working model is trained using a loss function including a cross-entropy loss on a union of a training batch and memory exemplars and a consistency loss on the memory exemplars.

In another aspect, embodiments of the disclosure provide an artificial intelligence system for making predictions from a sequence of images acquired by an image acquisition device at different time points. The system may include a storage device configured to store a stable model trained along with a working model and a plastic model. The training enforces a consistency among the working model, the stable model, and the plastic model. The working model is trained using a loss function including a cross-entropy loss on a union of a training batch and memory exemplars and a consistency loss on the memory exemplars. The system may further include a processor configured to apply the stable model to process the sequence of images to make the predictions.

In another aspect, embodiments of the disclosure provide a method for training an artificial intelligence inference model. The method may include receiving a training batch from a data stream and memory exemplars from a reservoir of episodic memories. The method may further include updating a working model based on a loss function that enforces a consistency between the working model and at least one of a stable model and a plastic model on the memory exemplars. The loss function includes a cross-entropy loss on a union of the training batch and the memory exemplars and a consistency loss on the memory exemplars. The method may further include updating the stable model and the plastic model based on the working model. The method may further include determining that the updated working model, the updated stable model, and the updated plastic model satisfy a training condition. The method may further include providing the stable model as the artificial intelligence inference model.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a schematic diagram of an exemplary system for complementary learning, according to some embodiments of the present disclosure.

FIG. 2 illustrates different models for complementary learning, according to some embodiments of the present disclosure.

FIG. 3 illustrates a schematic diagram of an exemplary image analysis system, according to some embodiments of the present disclosure.

FIG. 4 illustrates a schematic diagram of an exemplary image processing device, according to some embodiments of the present disclosure.

FIG. 5 illustrates a flowchart of an exemplary artificial intelligence method of making predictions from a sequence of images, according to some embodiments of the present disclosure.

FIG. 6A illustrates a flowchart of an exemplary method for training an artificial intelligence inference model based on CLS-ER, according to some embodiments of the present disclosure.

FIG. 6B shows pseudocode of an exemplary CLS-ER based method to train a model for complementary learning, according to some embodiments of the present disclosure.

FIG. 7 illustrates an exemplary data flow of training and evaluating a model for CLS-ER, according to some embodiments of the present disclosure.

Embodiments of the present disclosure will be described with reference to the accompanying drawings.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent an to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As discussed above, continual learning presents a challenge for DNNs. A goal of the embodiments of this disclosure is to gain insights from how the human brain excels at continual learning and mimic the process to enable efficient continual learning in DNNs. The embodiments aim to reduce forgetting of previous tasks, acquire new knowledge, and consolidate it with previously learned knowledge so that the models perform well on all the tasks seen so far, including recent and past examples.

Efficient lifelong learning in the human brain is enabled by a set of neurophysiological processing principles and multiple memory systems. Notably, the complementary learning system (CLS) theory explains how the interplay between rapid instance-based learning and slow structured learning is crucial for accumulating and retaining knowledge. By contrast, existing DNNs lack any such mechanism to regulate synaptic plasticity and stability.

To this end, some embodiments of the disclosure provide a novel ER method based on the complementary learning system in the brain, CLS-ER. The method maintains two exponentially weighted averaged models. In some embodiments, these models include a plastic model and a stable model, which differ in their frequency of update to mimic the rapid and slow adaptation of information. An exponentially weighted average is a first-order infinite impulse response filter that applies weighing factors which decrease exponentially. The weighting for each older piece of data decreases exponentially, never reaching zero. Thus, more recent data is favored, but older data always has an effect on the model. The use of an exponentially weighted average is described further, below.

In some embodiments, the working model receives feedback from both the plastic and stable models, which enforces consistency on the model's prediction on the memory samples. Thus, the working model effectively maintains a regulated balance between the stability and plasticity of the working model. CLS-ER does not utilize the task boundaries or make any assumption about the distribution of the data which makes it versatile and suited for “general continual learning.”

The ability to continuously learn from a changing environment is a hallmark of intelligence. In the human brain, the ability to continually acquire, refine, and transfer knowledge over time is mediated by a rich set of neurophysiological processing principles. A canonical theme in neuroscience is that intelligent behavior relies on multiple memory systems. In particular, the complementary learning systems theory posits that the hippocampus exhibits short-term adaptation and rapid learning of episodic information which is then gradually consolidated to the neocortex for slow learning of structured information. The interplay between the hippocampal and neocortical functionality is crucial for concurrently learning efficient representations for generalizations and the specifics of instance-based episodic memories.

The disclosed CLS-ER based learning methods attempt to mimic the human brain's slow and rapid adaptation of information in DNNs and have a mechanism for incorporating them into the working memory to enable better CL performance in DNNs.

The brain performs two complementary tasks that are critical for effective learning, namely generalizing across experiences and retaining memories of episodic events. The Complementary Learning Systems (CLS) approach provides a well-established theory for how the brain extracts the general statistical structure of the experiences with the goal of generalizing to novel situations and the specifics of the episodic memories. The interplay between episodic memory (specific experiences) and semantic memory (general structured knowledge) provides key insights into the mechanisms employed by the brain for efficiently consolidating knowledge.

CLS-ER is a continual learning method based on the complementary learning system in the brain that can scale to current computer vision datasets and achieve improved performance on standard benchmarks as well as more realistic general continual learning settings. Thus, CLS-ER is useful and performs well for present use cases, and also promises to be extensible and versatile.

The disclosed CLS-ER based learning methods mimic the fast and slow adaptation of information, by maintaining two additional exponentially weighted averaged models that are updated at different frequencies. In some embodiments, these two models include a stable model and a plastic model that supplement a working model. The stable model and the plastic model, which is updated more frequently than the stable model, maintain long-term and short-term semantic memories (learned representations) of the experienced events (training samples), respectively. Both of these models interact with the memory buffer (episodic memories) for efficiently replaying not just the memory samples but also the associated neural activities (activations).

In some embodiments, the objective of incorporating the fast and slow learning memories into the working model is achieved by adding a consistency term that encourages the working model to match its logits (model pre-softmax predictions) on the memory samples with the plastic model (on recent exemplars) and the stable model (on older exemplars), which can be considered as replaying the information encoded in the semantic memories. The logits here are the output of a linear layer without any activation function.

The softmax function, also known as the soft argmax or normalized exponential function is a generalization of the logistic function to multiple dimensions. The softmax function is often used as the last activation function of a neural network to normalize the output of a network to a probability distribution over predicted output classes.

In some embodiments, the softmax function (represented as σ(z)) takes as input a vector z of K real numbers and normalizes it into a probability distribution consisting of K probabilities proportional to the exponentials of the input numbers. Simply put, the softmax function applies the standard exponential function to each element of the input vector and normalizes these values by dividing by the sum of all of these exponentials. This normalization ensures that the sum of the components output vector σ(z) is 1.

In some embodiments, the relevant exponential base for the logits and the softmax function may be e. However, other exponential bases may be used in different embodiments.

In some embodiments, the “softmax” function may be a smooth maximum (a smooth approximation to the maximum function), as it is conventionally known in machine learning, or a smooth approximation to an argmax function (a function whose value is which index has the maximum).

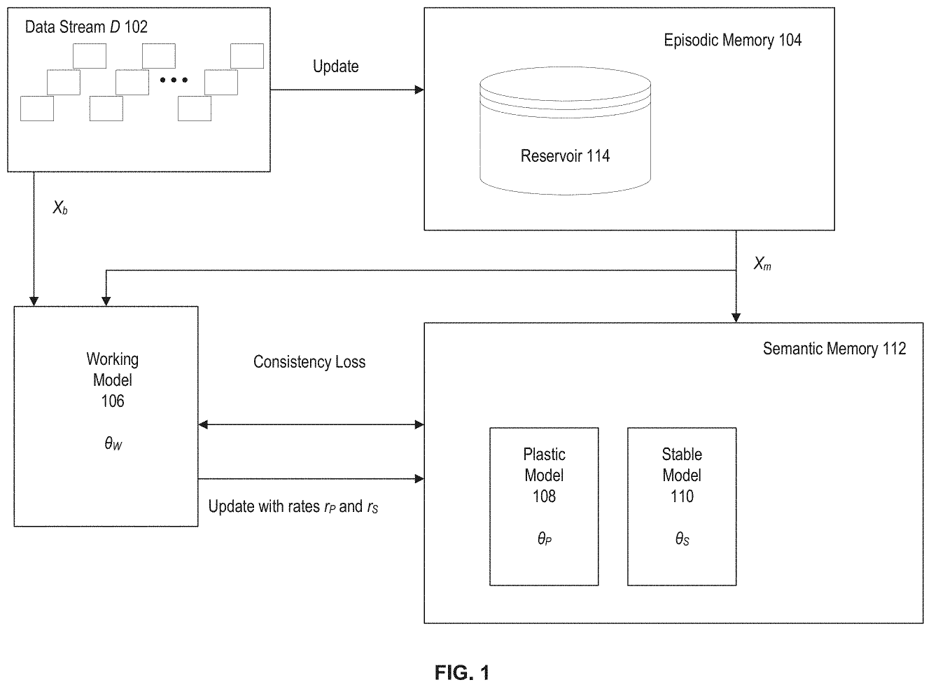

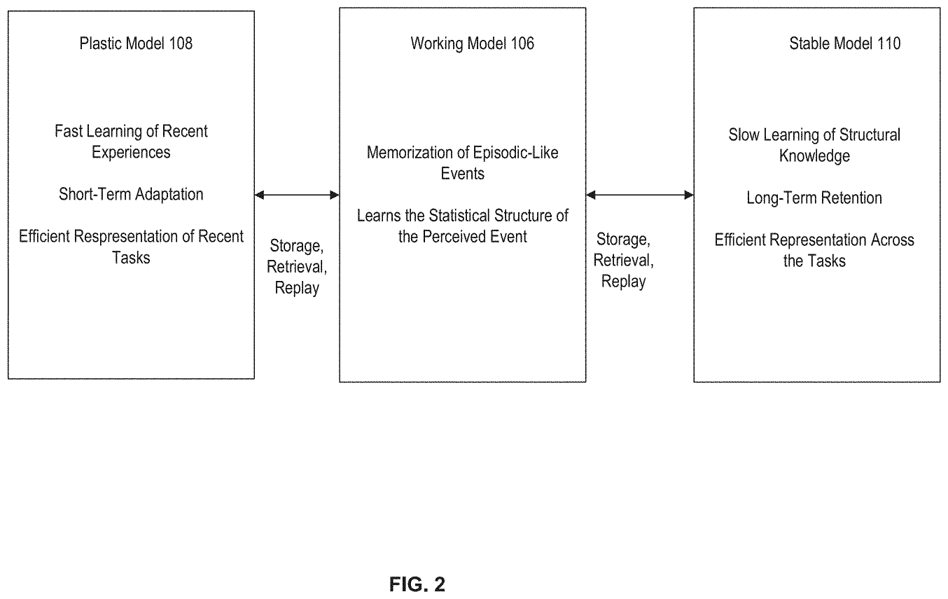

The interplay between the working model and the short-term and long-term semantic memories enables efficient knowledge consolidation and maintains a regulated balance between the model's plasticity and stability. FIGS. 1-2, described further, below, highlight the parallels between CLS theory in the brain and the main components of the method.

In some embodiments, the disclosed CLS-ER based methods involve training a working model f(.;θj) on a data stream D sampled from a non-IDD (independent and identically distributed) distribution, such that the distribution is neither independent nor identically distributed. The working model maintains two exponentially weighted average models as semantic memories, specifically the plastic model f(.;θp) and the stable model f(.;θs).

Because CLS-ER is intended to be a versatile general incremental learning method, the disclosed methods do not require the task boundaries or any strong assumptions about the distribution of the tasks or samples. The disclosed CLS-ER based learning methods employ a reservoir sampling method for maintaining a small episodic memory M, which attempts to match the distribution of the data stream D and to give each sample an equal opportunity of being added to the episodic memory.

In some embodiments, at each training step, the working model receives the training batch X_{b} from the data stream and retrieves exemplars Xₘ from the episodic memory. Training then involves a retrieval of semantic information about the exemplars from the two semantic memories, as described further, below. In some embodiments, the parameters of the plastic model and the stable model are designed so that the plastic model has higher performance on recent tasks while the stable model prioritizes retaining information on the older tasks.

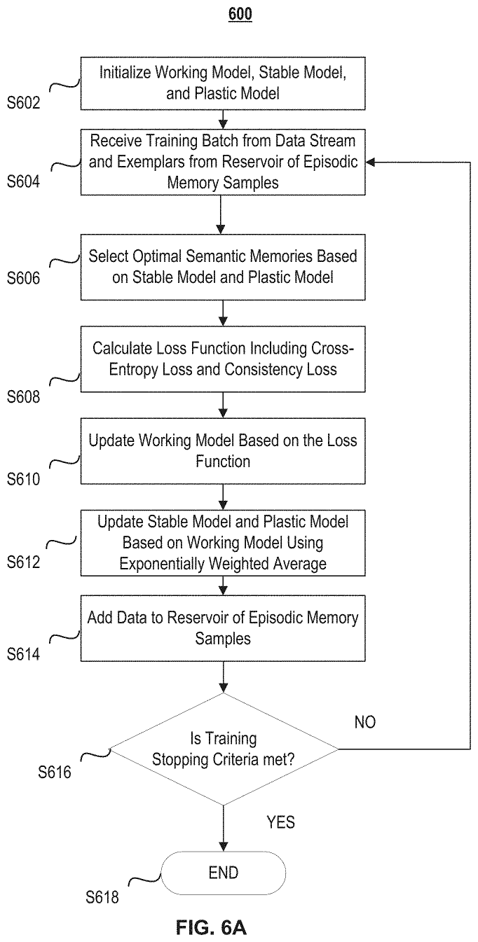

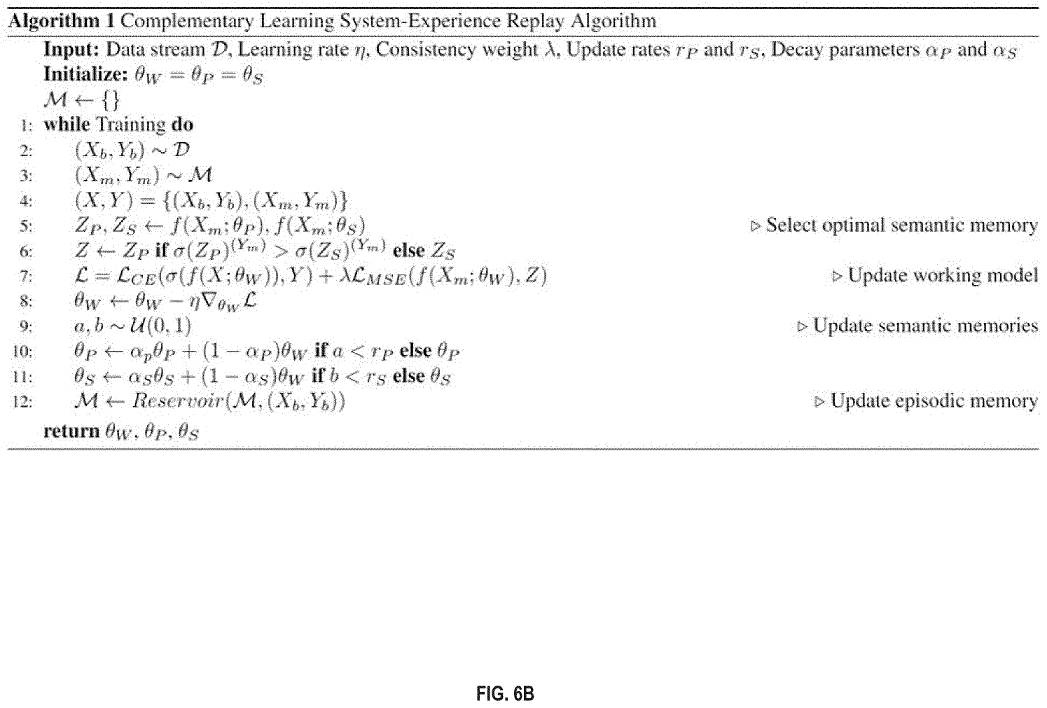

In some embodiments, in order not to utilize any task information, a simple and flexible approach is adopted whereby, for each exemplar, embodiments select the replay logits Z, chosen from between the plastic and stable model logits, based on which model has the highest softmax score for the ground truth class, as shown at lines 5-6 in Algorithm 1 in FIG. 6B and described further, below.

In some embodiments, the replay logits from the semantic memories are then used to enforce a consistency term on the working model so that the working model does not deviate from the already learned experiences. Thus, the working model is updated with a combination of the cross-entropy loss on the union of the data stream and episodic memory samples, denoted as X, and the consistency loss on the exemplars, denoted as X.

In some embodiments, the training method may use a loss function such as one defined by Equation (1), below. This function is further described in greater detail with respect to FIG. 6B.

[symbol]

= [symbol] _{CE}(σ(f(X;θW),Y)+λ [symbol] _{MSE}(ƒ(Xₘ;θW),Z) (1)

In Equation (1), σ is the softmax function, λ is the regularization parameter, and L_{MSE} is the mean square error loss. Additionally, L_{CE} is the cross-entropy loss. After updating the working model (for example, using gradient descent), the disclosed training methods stochastically update the plastic and stable models with rates r_{P} and r_{S}. In some embodiments, r_{P}≥r_{S} which means the plastic model is updated more frequently. In some embodiments, the plastic model is representative of recent training examples, and the stable model is representative of older training examples for an extended period of time.

In some embodiments, the plastic and stable models are updated by taking an exponentially weighted average of the working model parameters with decay parameters α_{P} and α_{S}, respectively. For example, Equation (2) shows an exemplary formula for updating the model parameters of the plastic model and the stable model.

θ_{{P,S}}=α_{{P,S}}θ_{{P,S}}+(1−α_{{P,S}})θ_{W} (2)

For example, the decay parameters are selected to be α_{P}≤α_{S} so that the plastic model mimics the rapid adaptation of information. By contrast, the stable model mimics slow structured retention memories. Additional details of one exemplary training method to train the models are provided in Algorithm 1 of FIG. 6B, as pseudocode.

FIG. 1 illustrates a schematic diagram of an exemplary system for complementary learning, according to some embodiments of the present disclosure. FIG. 1 includes a data stream D 102, which, e.g., includes a plurality of images that may be used as training examples. Episodic memory 104 uses a reservoir sampling method to maintain a reservoir database 114. The reservoir database 114 stores the data samples for use as a reservoir of episodic memories. The episodic memory 104 provides the data samples X_{M} to semantic memory 112 and working model 106 during training. Working model 106 is defined by a set of model parameters θ_{W}. Semantic memory 112 includes a plastic model 108, defined by its model parameters θ_{P}, and a stable model 110, defined by its model parameters θ_{S}.

Working model 106 and semantic memory 112 interact with one another. For example, the semantic memory 112 has as instances plastic model 108 and stable model 110 which may be updated (by updating their respective model parameters) with rates r_{P} and r_{S}, as indicated in FIG. 6B. Additionally, working model 106 is updated based on a consistency loss, in addition to the cross-entropy loss, based on plastic model 108 and/or stable model 110, also as indicated in FIG. 6B.

FIG. 2 illustrates different models for complementary learning, according to some embodiments of the present disclosure. FIG. 2 shows a working model 106, a plastic model 108, and a stable model 110. FIG. 2 also presents characteristics of these respective models.

For example, working model 106 memorizes episodic-like events. The working model 106 also learns the statistical structure of the perceived event. The plastic model 108 is adapted for fast learning of recent experiences. In particular, the plastic model 108 is adapted for short-term adaptation and efficient representation of the recent tasks. The stable model 110 is adapted for slow learning of structural knowledge. In particular, the stable model 110 is adapted for long-term retention. Accordingly, the stable model 110 may provide efficient representation across tasks. Thus, the working model 106, the plastic model 108, and the stable model 110 are trained to have different properties, as defined by how they are updated.

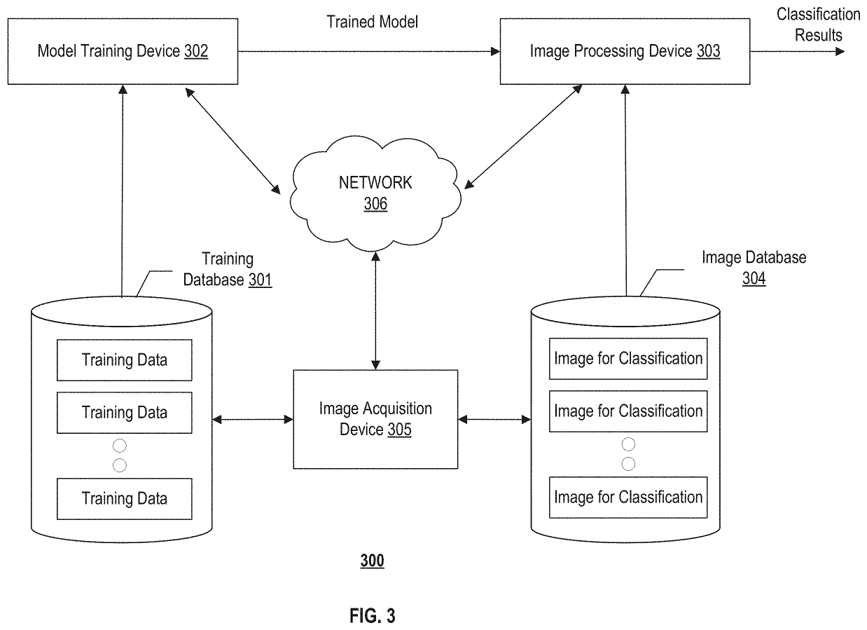

FIG. 3 illustrates a schematic diagram of an exemplary image analysis system 300, according to some embodiments of the present disclosure. As shown in FIG. 3, image analysis system 300 may include components for performing two phases, including a training phase and a prediction phase. The prediction phase may also be referred to as a classification phase or a recognition phase. In some embodiments, the prediction phase takes raw images and interprets them or otherwise lends them meaning. For example, the prediction phase may perform image analysis tasks such as image segmentation, image classification, object recognition, movement prediction, etc.

To perform the training phase, image analysis system 300 may include a training database 301 and a model training device 302. To perform the prediction phase, image analysis system 300 may include an image processing device 303 and an image database 304. In some embodiments, image analysis system 300 may include more or less of the components shown in FIG. 3. For example, when a prediction model for providing a prediction based on the images is pre-trained and provided, image analysis system 300 may include only image processing device 303 and image database 304. As another example, when image analysis system 300 may include only training database 301 and model training device 302 for performing only the model training tasks.

Image analysis system 300 may optionally include a network 306 to facilitate the communication among the various components of image analysis system 300, such as databases 301 and 304, and devices 302, 303, and 305. For example, network 306 may be a local area network (LAN), a wireless network, a cloud computing environment (e.g., software as a service, platform as a service, infrastructure as a service), a client-server, a wide area network (WAN), etc. In some embodiments, network 306 may be replaced by wired data communication systems or devices.

In some embodiments, the various components of image analysis system 300 may be remote from each other or in different locations and be connected through network 306 as shown in FIG. 3. In some alternative embodiments, certain components of image analysis system 300 may be located on the same site or inside one device. For example, training database 301 may be located on-site with or be part of model training device 302. As another example, model training device 302 and image processing device 303 may be inside the same computer or processing device.

Model training device 302 may use the training data received from training database 301 to train a prediction model for analyzing an image received from, e.g., image database 304, in order to provide a prediction or a recognition result. As shown in FIG. 3, model training device 302 may communicate with training database 301 to receive one or more sets of training data. In certain embodiments, each set of training data may include ground truth (e.g., image classification labels, image recognition results, etc.). The trained prediction model may include one or more inference models. For example, the prediction model may take the form of a working model 106, a plastic model 108, and a stable model 110. An exemplary method for training such models is described in connection with FIGS. 6A-6B.

Training images stored in training database 301 may be obtained from an image database containing previously acquired images that have been analyzed and associated with their ground truths. In some embodiments, training database 301 may include an episodic database (e.g., reservoir database 114) that stores the data samples for use as a repository of episodic memories. The data samples stored in the episodic database include pairs of images and corresponding logits provided by plastic model 108 and/or stable model 110.

In some embodiments, in the training phase, the images may be processed by model training device 302 to identify specific types of images and image characteristics or image features. The prediction results are compared with an initial probability analysis, and based on the difference, the model parameters are improved/optimized by model training device 302. For example, an initial classification or prediction may be performed and verified.

In some embodiments, the training phase may be performed “online” or “offline.” An “online” training refers to performing the training phase contemporarily with the prediction phase, e.g., learning the model in real-time just prior to analyzing an image. An “online” training may have the benefit to obtain a most updated inference model based on the training data that is then available.

However, an “online” training may be computationally costly to perform and may not always be possible if the training data is large and/or the model is complicated. The learned model trained offline is saved and reused for analyzing images. Moreover, the use of the working model 106, the plastic model 108, and stable model 110 allows training and prediction to better reflect how the training data from training database 301 changes over time.

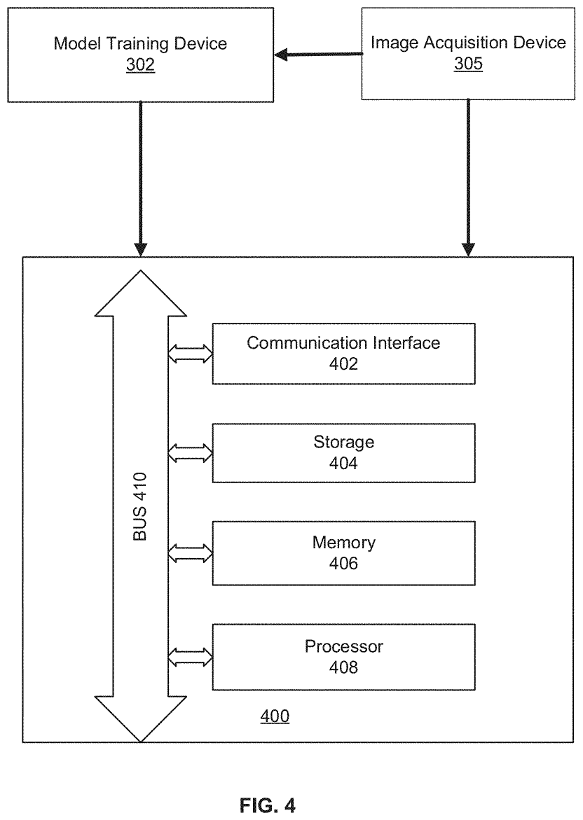

Model training device 302 may be implemented with hardware specially programmed by software that performs the training process. For example, model training device 302 may include a processor and at least one non-transitory computer-readable medium, as discussed in further detail in connection with FIG. 4. The processor may conduct the training by performing instructions of a training process stored in the computer-readable medium. Model training device 302 may additionally include input and output interfaces to communicate with training database 301, network 306, and/or a user interface (not shown).

The user interface may be used for selecting sets of training data, adjusting one or more parameters of the training process, selecting, or modifying a framework of the inference model(s), providing prediction results associated with an image for training. However, the training as provided for in FIGS. 6A-6B is able to operate automatically once the data stream is provided and does not require user intervention during the process to operate successfully.

FIG. 6A illustrates a flowchart of an exemplary method 600 for training an artificial intelligence inference model based on CLS-ER, according to some embodiments of the present disclosure. The steps performed in method 600 of FIG. 6A are described using pseudocode shown in FIG. 6B, as an example. FIG. 6B illustrates a Complementary Learning System-Experience Replay Algorithm that is used to train a working model 106, a plastic model 108, and a stable model 110 to manage learning of multiple DNNs over time. FIGS. 6A and 6B will be described together.

FIG. 6B defines the CLS-ER algorithm. Specifically, FIG. 6B includes a data stream D, a learning rate q, a consistency weight A, update rates r_{P} and r_{S}, and decay parameters α_{P} and α_{S}. These input parameters are described further, below, in the context of how they are used in the CLS-ER algorithm.

In step S602, method 600 initializes the working model, the stable model, and the plastic model. Such initialization prepares the models for the training process. The initialization assigns initial values to the model parameters of the working model θ_{W}, model parameters of the plastic model θ_{P}, and model parameters of the stable model θ_{S}, respectively. In some embodiments, the initialization may set the three set of model parameters to be identical, i.e., θ_{W}=θ_{P}=θ_{S}, as shown in FIG. 6B. In some alternative embodiments, the models may be initialized to mimic previously trained models that are for the same or similar prediction tasks and data acquisition settings. For example, if models are trained for one autonomous vehicle driving in a road segment, the model parameters of those trained models can be used to initialize models for another autonomous vehicle driving in the same or similar road segment. Such initialization may speed up the convergence of the training process, thus saving computational cost. Method 600 also initializes M, which is the episodic memory, to the empty set as no information is yet available to be part of the episodic memory.

After initialization, method 600 then iterates steps S604-S614 to update the model parameters θ_{W}, θ_{P} and θ_{S}, until the algorithm converges. For example, in line 1 of FIG. 6B, the pseudocode defines a while loop. Specifically, the main body of the pseudocode that provides for the CLS-ER algorithm is a while loop that provides a series of training operations (provided in lines 2-12) until the training is complete. For example, the training may continue until the results of one or more of the models satisfy a predetermined metric or threshold, until the training while loop has been performed a set number of times, or until some other condition is met that indicates that no further training is necessary, such as that the models have stabilized and are no longer changing significantly as training occurs.

In step S604, method 600 receives a training batch from a data stream and exemplars from a reservoir of episodic memory samples. The training batch and the exemplars are chosen to allow successful updating of the working model. The training batch includes training examples used to update the models to reflect new data, while the exemplars include training examples, used to help the model retain learning it has already accomplished.

For example, in line 2 of FIG. 6B, the algorithm defines the probability distribution of the training batch, specifically (X_{b}, Y_{b}) as being distributed based on the distribution of the data stream D. Accordingly, the training batch is sampled from the data stream D, and has the same distribution, so it can be used as a source of data when training the models for prediction and classification in accordance with the data stream D.

In line 3 of FIG. 6B, the algorithm samples the exemplars, specifically (Xₘ, Yₘ) from the episodic memory M. As data for the episodic memory is stored in reservoir database 114, as shown in FIG. 1, the exemplars may be sampled from reservoir database 114. The reservoir sampling assigns equal probability to each incoming samples to be added to the memory buffer and the distribution of the samples in the memory buffer tracks the overall data distribution for all the tasks.

In line 4 of FIG. 6B, the algorithm defines (X, Y) as the union of the training batch and the exemplars, for use in updating the working memory.

In step S606, method 600 selects optimal semantic memories based on the stable model and the plastic model. Specifically, method 600 considers characteristics of the union of the training batch and the exemplars and uses such characteristics to select an optimal semantic memory. For example, in lines 5 and 6 of FIG. 6B, the algorithm selects an optimal semantic memory. The selection involves two constituent operations. First, in line 5, the replay logits Z_{P} and Z_{S} are extracted for each exemplar. Then, one of replay logits Z_{P} and Z_{S} is selected as Z based on which has the highest softmax score for the ground truth class. The ground truth class represents the information that is known to be true. This selection is represented mathematically in line 6 of FIG. 6B.

In step S608, method 600 calculates the value of a loss function based on the current model outputs and the logits selected in step S606. The loss function includes a cross-entropy loss and a consistency loss. This loss function considers the cross-entropy loss on the union of the data stream and the episodic memory samples X, as well as a consistency loss based on the exemplars Xm. For example, in line 7 of FIG. 6B, the algorithm calculates a value of the loss function. The loss function is used to update the working model. The loss function is defined, above, as Equation (1), and is reproduced here for further discussion:

[symbol]

= [symbol] _{CE}(σ(f(X;θ_{W})),Y)+ [symbol] _{MSE}(f(Xₘ;θ_{W}),Z) (1)

Here, L denotes the overall loss function. L_{CE} represents a cross-entropy loss on the union of the data stream and episodic memory samples X. The L_{MSE} term is a mean square error loss term, which is managed by a regularization parameter λ. The L_{MSE} term acts as a consistency term, in that the current state of the working model is evaluated using the Z values derived in lines 5-6 to establish a discrepancy, which can then be corrected as a part of using the overall loss function. The loss function is calculated to help determine how the working model deviates from achieving correct prediction results and can be used to train the working model to have parameters that provide better prediction results.

In step S610, method 600 updates the working model based on the calculated value of the loss function. For example, in line 8 of FIG. 6B, the algorithm uses the value of loss function calculated in line 8 to update the working model. Specifically, the update uses a gradient descent approach, where V represents the gradient operator. To use such a gradient descent approach, the working model parameter θ_{W} is updated to reflect the product of the gradient of the working model and a learning rate n and the loss function L, as calculated in line 7. It may be appropriate to adjust the learning rate η for different use cases. For example, if the learning rate is too small, it will take a very long time to train, but if the learning rate is too large, the training may not be performed successfully. Although a gradient descent is used for updating the working model as shown in FIG. 6B, it is contemplated other types of updating may be used in other embodiments. For example, gradient descent sometimes encounters problems with local minima and maxima that are not global minima and maxima.

In step S612, method 600 updates the stable model and the plastic model based on the model parameters of the working model using an exponentially weighted average. In general, the plastic model performs a rapid adaptation to new information, while the stable model adapts more slowly, thereby retaining information longer.

For example, in lines 9-11 of FIG. 6B, the plastic and static models are updated. In some embodiments, method 600 uses two variables a and b to determine whether the plastic model and the stable model should be updated in the current iteration. In some embodiments, such updating can be done stochastically. For example, in line 9 of FIG. 6B, variables a and b are distributed according to the continuous uniform probability distribution U(0, 1). Variables a and b are then compared with the update rates r_{P} and r_{S}, respectively, to determine if the models should be updated.

For example, in line 10 of FIG. 6B, if a<r_{P}, an updating is performed for the plastic model. Specifically, the plastic model takes an exponentially weighted average of the working model parameters with decay parameter α_{P}. The updating is summarized by the following Equation (2), reproduced here:

θ_{{P,S}}=α_{{P,S}}θ_{{P,S}}+(1−α_{{P,S}})θ_{W} (2)

Otherwise, if a>=r_{P}, the plastic model is not updated and its model parameters OP remain the same. In line 11 of FIG. 6B, if b<r_{S}, a similar updating to that performed in line 10 for the plastic model is performed for the stable model, except that the decay parameter used is as. Otherwise, if b>=r_{S}, the stable model is not updated and its model parameters θ_{S} remain the same. Because the update rate of the plastic model is higher than that of the stable model, i.e., r_{P}≥r_{S}, the plastic model is updated more frequently than the stable model.

Note that α_{P}≤α_{S} as so that the plastic model mimics the rapid adaptation of information while the stable model mimics slow structured retention memories. For inference, embodiments use the stable model as it retains long-term memory across the tasks, consolidates structural knowledge, and is characterized by efficient learned representations for generalization, as presented in FIGS. 1-2.

In step S614, method 600 adds data to a reservoir of episodic memory samples. In some embodiments, the reservoir is designed to retain a random sampling of memory samples, so that the reservoir will resemble the overall distribution of samples. For example, in line 12 of FIG. 6B, the algorithm updates the episodic memory. Specifically, the algorithm adds information from the training batch provided from the data stream into the reservoir to be stored as episodic memory M. As discussed, the episodic memory is updated based on the training batch in a way that causes the episodic memory to have a distribution resembling that of the data stream D.

In step S616, method 600 checks to see if a training stopping criteria has been met. If the stopping criteria is not met (step S616:NO), method 600 returns to step S604. Otherwise, if the stopping criteria is met (step S616: YES), method 600 proceeds to step S618, where the training concludes. For example, if one or more of the models meets or exceeds a threshold of a performance metric, method 600 may decide that the training is complete, and provide the parameters of the trained models for subsequent use. As shown in FIG. 6B, after line 12, if the training while loop continues, the training resumes at line 2 of FIG. 6B. If the training is complete, the training method returns θ_{W}, θ_{P}, and θ_{S}, which are the parameters of the trained working model 106, the plastic model 108, and the stable model 110, respectively.

Consistent with some embodiments, the trained stable model may be used by the image processing device 303 to analyze new images for prediction purposes. Image processing device 303 may receive one or more prediction models from model training device 302, trained as described. Image processing device 303 may include a processor and a non-transitory computer-readable medium (discussed in additional detail in connection with FIG. 4). The processor may perform instructions of an image analysis program stored in the medium.

Image processing device 303 may additionally include input and output interfaces (discussed in additional detail in connection with FIG. 4) to communicate with image database 304, network 306, and/or a user interface (not shown). The user interface may be used for selecting images for analysis, prediction, and/or recognition, initiating the analysis process, and displaying the prediction results.

Image processing device 303 may communicate with image database 304 to receive images. The images may be acquired by image acquisition device 305. In some embodiments, image acquisition device 305 may be a sensor such as a camera, a video camera, a LiDAR, a medical imaging scanner, etc. The images acquired may depict the environment or scene around the sensor. For example, image acquisition device 305 may include one or more sensors equipped on an autonomous or semi-autonomous vehicle, such as a camera and a LiDAR, to capture images of the environment surrounding the vehicle. As another example, image acquisition device 305 may be a surveillance camera that acquires images of a surrounding to capture objects appearing in the surrounding and their activities.

Image processing device 303 may perform an initial processing on the images. For example, various preprocessing may be performed on the images so that it is easier to predict the images. In some embodiments of the present disclosure, image processing device 303 may perform an analysis to identify the type or attribute of the image. For example, image processing device 303 may generate a probability score for a type or feature of the image. Image processing device 303 may further generate and provide a prediction result based on the probability score for the underlying subject.

FIG. 4 illustrates a schematic diagram of an exemplary image processing device 400, according to some embodiments of the present disclosure. Systems and methods of the present disclosure may be implemented using a computer system, such as shown in FIG. 4. Image processing device 400 may be an embodiment of image processing device 303 described in connection with FIG. 3. In some embodiments, image processing device 400 may be a dedicated device or a general-purpose device. For example, image processing device 400 may be a computer customized for processing image data acquisition and image data processing tasks, or a server in a cloud environment. The image processing device 400 may include one or more processor(s) 408, one or more storage device(s) 404, and one or more memory device(s) 406. Processor(s) 408, storage device(s) 404, and memory device(s) 406 may be configured in a centralized or a distributed manner. Image processing device 400 may also include an image database (optionally stored in storage device 404 or in a remote storage), an input/output device (not shown, but which may include a touch screen, keyboard, mouse, speakers/microphone, or the like), a network interface such as communication interface 402, a display (not shown, but which may be a cathode ray tube (CRT), liquid crystal display (LCD), light emitting diode (LED), or the like), and other accessories or peripheral devices. The various elements of image processing device 400 may be connected by a bus 410, which may be a physical and/or logical bus in a computing device or among computing devices.

Processor 408 may be a processing device that includes one or more general processing devices, such as a microprocessor, a central processing unit (CPU), a graphics processing unit (GPU), and the like. More specifically, processor 408 may be a complex instruction set computing (CISC) microprocessor, a reduced instruction set computing (RISC) microprocessor, a very long instruction word (VLIW) microprocessor, a processor running other instruction sets, or a processor that runs a combination of instruction sets. Processor 408 may also be one or more dedicated processing devices such as application specific integrated circuits (ASICs), field programmable gate arrays (FPGAs), digital signal processors (DSPs), system-on-chip (SoCs), and the like.

Processor 408 may be communicatively coupled to storage device 404 and/or memory device 406 and configured to execute computer-executable instructions stored therein. For example, as illustrated in FIG. 4, bus 410 may be used, although a logical or physical star or ring topology would be examples of other acceptable communication topologies. Storage device 404 and/or memory device 406 may include a read only memory (ROM), a flash memory, random access memory (RAM), a static memory, a volatile or non-volatile, magnetic, semiconductor, tape, optical, removable, nonremovable, or other type of storage device or tangible (e.g., non-transitory) computer readable medium. In some embodiments, storage device 404 may store computer-executable instructions of one or more processing programs, learning networks used for the processing (e.g., models 106, 108, and 110), and data (e.g., images for prediction/classification) generated when a computer program is executed. The data may be read from storage device 404 one by one or simultaneously and stored in memory device 406. Processor 408 may execute the processing program to implement each step of the methods described below. Processor 408 may also send/receive data to/from storage device 404 and/or memory device 406 via bus 410.

Image processing device 400 may also include one or more digital and/or analog communication (input/output) devices, not illustrated in FIG. 4. For example, the input/output device may include a keyboard and a mouse or trackball that allow a user to provide input. Image processing device 400 may further include a network interface, illustrated as communication interface 402, such as a network adapter, a cable connector, a serial connector, a USB connector, a parallel connector, a high-speed data transmission adapter such as optical fiber, USB 3.0, lightning, a wireless network adapter such as a Wi-Fi adapter, or a telecommunication (3G, 4G/LTE, 5G NR, etc.) adapter and the like. Image processing device 400 may be connected to a network through the network interface. Image processing device 400 may further include a display, as mentioned above. In some embodiments, the display may be any display device suitable for displaying an image and its prediction or classification results. For example, the image display may be an LCD, a CRT, or an LED display.

Image processing device 400 may be connected to model training device 302 and image acquisition device 305 as discussed above with reference to FIG. 3. Other implementations are also possible, according to other embodiments.

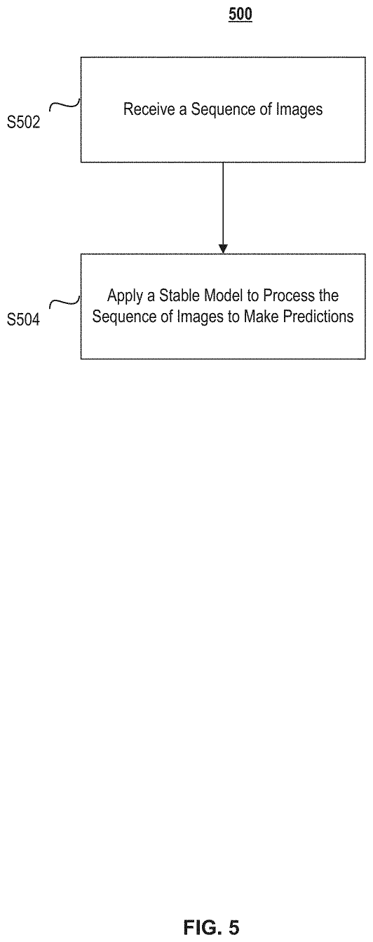

FIG. 5 illustrates a flowchart of an exemplary artificial intelligence method of making predictions from a sequence of images, according to some embodiments of the present disclosure.

In step S502, method 500 receives a sequence of images. For example, these images may be a sequence of images acquired at different time points within a time window. In some embodiments, the sequence of images may be captured by a sensor such as a camera, a video camera, a LiDAR, a medical imaging scanner, etc. The sequence of images depict the environment or scene around the sensor. In some embodiments, the sequence of images may be ones that are captured by different sensors located in the environment. For example, an autonomous or semi-autonomous vehicle may be equipped with multiple sensors, such as cameras and LiDARs, to capture images of the environment surrounding the vehicle. The images may depict the road conditions, signs along the road, traffic lights, other static or moving objects in the surrounding (e.g., other vehicles, pedestrians, trees, etc.). The content depicted by the sequence of images vary over time, due to the movement of the vehicle as well as the movement of other objects. A goal of method 500 may be performed to make certain predictions based on the images, such as performing a classification task on the images. For example, method 500 may be performed to predict whether a vehicle may collide with an obstacle (e.g., a static or moving object in the environment) and accordingly make an autonomous driving decision, e.g., to switch lanes, to slow down or speed up, to generate warnings, etc., to avoid the potential collision.

To facilitate more accurate and efficient predictions, method 500 of FIG. 5 uses a prediction model that is trained using continual learning. Continual learning incorporates knowledge learned from previous images in the sequence while making predictions on the subsequent images. Because the sequence of images is captured of a general environment although with time-varying changes, the images usually share important features and have strong correlations, learning made from previous images therefore is helpful to enrich the agent's knowledge in making subsequent predictions. Accordingly, method 500 may use prediction models that are trained to let the more recent images take a greater effect in performing the prediction tasks. For example, the prediction models include a stable model trained based on CLS-ER algorithms.

The training enforces a consistency between the working model and at least one of the stable model and the plastic model. The training updates the stable model at a first training rate and updates the plastic model at a second training rate based on the working model, the first training rate being a slower rate than the second training rate.

Accordingly, by using different models, and by training models in the ways discussed in this application, it is possible to better reflect learning over time, such that all training data is considered when training the model, but more recent training data has a larger effect on the model. Furthermore, the size of this effect may differ, based on parameters set to change rates, such as update and decay rates, when training the models. Training of such prediction models is described above in connection with FIGS. 6A-6B.

In step S504, method 500 applies the trained stable model 110 to process the sequence of images to make predictions. Once stable model 110 is applied to the images, predictions can be made based on the images, such as classifying the images, or recognizing features of the images. For example, based on images captured by sensors on an autonomous vehicle, the stable model can recognize and classify the objects depicted in the images, and make certain predictions based on knowledge learned through the training process. For example, a self-driving vehicle constantly interacting with the environment may need to acquire new knowledge, e.g., new road signs or change in the shape/appearance of sign boards, as its owner moves from one country to another. A trained stable model can be applied by the self-driving vehicle to acquire such new knowledge based on image acquired from the new environment. However, the predictions are not limited to these examples, and may include other predictions, such as recognition tasks, machine vision tasks, or predictions for use in other learned tasks.

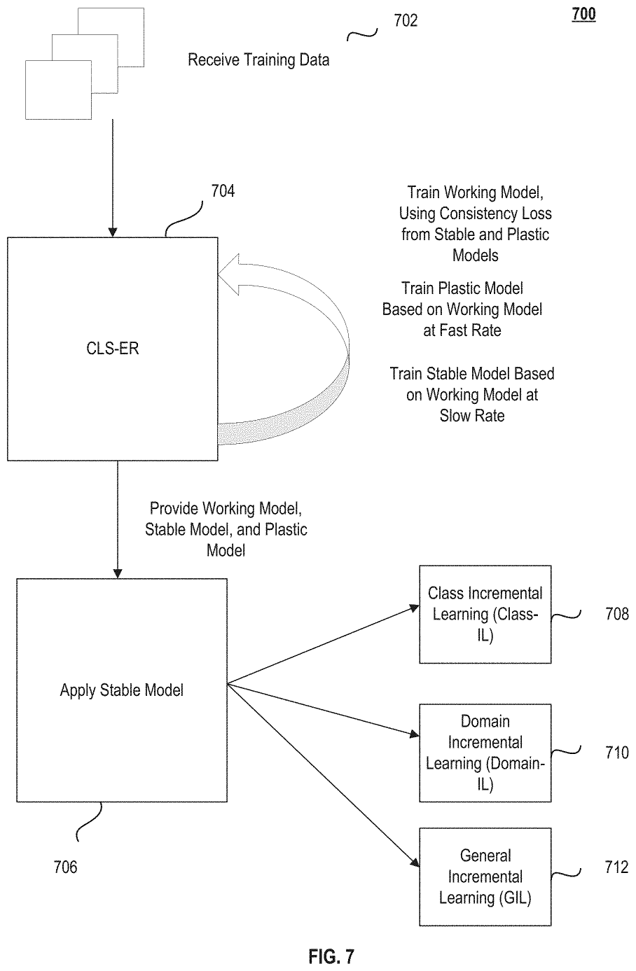

FIG. 7 illustrates an exemplary data flow 700 of training and evaluating a model trained for CLS-ER, according to some embodiments of the present disclosure. In 702, the model begins by receiving training data. For example, the training data may be a series of images for prediction and/or classification that arrive over a period of time. This training data corresponds to data stream D in FIG. 1. In 704, a CLS-ER is trained. The training process includes training the working model, using the consistency loss from stable and plastic models. The training process is described above in connection with FIGS. 6A-6B.

After training, the stable model 110 is used as the CLS-ER. In 706, the CLS-ER applies the stable model 110.

There is a plethora of evaluation protocols in the CL literature, each of which biases the evaluation towards a certain approach. In some embodiments, an extensive and robust evaluation may be conducted on the model trained for CLS-ER to gauge the versatility of the method.

An experimental protocol that trains the method on a long sequence of tasks where the boundaries between the tasks are not distinct and the tasks themselves are not disjoint and the method does not make sure of task boundaries during training or testing can be considered as adhering to desired qualities of models. Examples focus on the aforementioned setting which can be considered as General Incremental Learning (GIL) setting. Here, examples provide a broad categorization of these evaluation protocols which test different aspects of CL.

In one example, the stable model can be applied for class incremental learning (Class-IL) 708. Class-IL refers to the CL scenario where new classes are added with each subsequent task and the agent must learn to distinguish not only amongst the classes within the current task but also across previous tasks. Class-IL measures how well the method can learn general representations, accumulate, consolidate, and transfer the acquired knowledge to learn efficient representations and decision boundaries for all the classes seen so far. It is possible to test the CLS-ER with various Class-IL benchmarks. These represent Class-IL settings of increasing dataset complexity as well as longer sequences.

While it is an important and challenging benchmark, it assumes that each subsequent task will have the same number of disjoint classes and have uniform samples for each class which is not representative of real-world scenarios. Such benchmarks do not consider the related Task Increment Learning (Task-IL) setting as it assumes the availability of task labels at both training and inference which cannot truly be considered as a CL task.

In another example, the stable model can be applied for domain incremental learning (Domain-IL) 710. Domain-IL refers to the CL scenario where the classes remain the same in each subsequent task but the input distribution changes. For example, a use case may be Rotated-MNIST where each task contains digits rotated by a fixed angle between 0 and 180 degrees. Examples do not consider the related popular evaluation protocol Permuted-MNIST that applies a fixed random permutation to the pixels for each task as it violates the cross-task resemblance desiderata and deviates from the goal of continual learning.

In yet another example, the stable model is applied for general incremental learning (GIL) 712. The aforementioned CL scenarios fail to assimilate the challenges in the real world, which include settings where the task boundaries are blurry, and the learning agent must instead learn from a continuous stream of data in which classes can reappear and have different data distributions. The CL method, when dealing with a GIL task, must deal with the issues of sample efficiency, imbalanced classes, and efficient transfer of knowledge in addition to preventing catastrophic forgetting.

To test the efficacy of the method in this challenging setting, it is possible to consider two GIL evaluation protocols. MNIST-360 models a stream of data which presents batches of two consecutive MNIST images with each sample rotated at an increasing angle and the sequence is repeated three times. This exposes the model to both a sharp distribution shift when the class changes and a smooth rotational distribution shift. However, the number of classes in each task and the samples are uniform.

The Generalized Class Incremental Learning (GCIL) utilizes probabilistic modeling to sample the classes and data distributions in each task. Hence, the number of classes in each task is not fixed, the classes can overlap and the sample size for each class can vary.

Thus, the present approaches that use CLS-ER provide good results when applied to several types of incremental learning, specifically class-IL 708, domain-IL 710, and GIL 712. These are all examples of CL in the context of different kinds of prediction tasks that show that CLS-ER works well. As a result of these exemplary evaluations, it can be seen that CLS-ER is well suited to providing good performance for predication and classification tasks in machine vision, where CL is relevant to successful image classification and computer vision tasks.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. An artificial intelligence method of making predictions from a sequence of images, comprising:
receiving the sequence of images acquired at different time points; and
applying a stable model to process the sequence of images to make the predictions, wherein the stable model is trained along with a working model and a plastic model, wherein the training enforces a consistency among the working model, the stable model and the plastic model, wherein the working model is trained using a loss function including a cross-entropy loss on a union of a training batch and memory exemplars and a consistency loss on the memory exemplars.

2. The artificial intelligence method of claim 1, wherein the training updates the stable model at a first training rate and updates the plastic model at a second training rate based on the working model, the first training rate being a slower rate than the second training rate

3. The artificial intelligence method of claim 1, wherein the training batch is from a data stream and the memory exemplars are from a reservoir of episodic memories.

4. The artificial intelligence method of claim 1, wherein the consistency loss is based on logits generated by the working model on the memory exemplars and replay logits chosen for the memory exemplars from the plastic model or the stable model.

5. The artificial intelligence method of claim 4, wherein the loss function is a weighted combination of the cross-entropy loss and the consistency loss, wherein the consistency loss is a mean squared error between logits generated by the working model on the memory exemplars and replay logits from the plastic model or the stable model.

6. The artificial intelligence method of claim 1, wherein parameters of the stable model and the plastic model are each updated using an exponentially weighted average of parameters of the working model with respective decay parameters at the first training rate and the second training rate, respectively.

7. An artificial intelligence system for making predictions from a sequence of images acquired by an image acquisition device at different time points, comprising:
a storage device configured to store a stable model, wherein the stable model is trained along with a working model and a plastic model, wherein the training enforces a consistency among the working model, the stable model and the plastic model, wherein the working model is trained using a loss function including a cross-entropy loss on a union of a training batch and memory exemplars and a consistency loss on the memory exemplars; and
a processor configured to apply the stable model to process the sequence of images to make the predictions.

8. The artificial intelligence system of claim 7, wherein the training updates the stable model at a first training rate and updates the plastic model at a second training rate based on the working model, the first training rate being a slower rate than the second training rate.

9. The artificial intelligence system of claim 7, wherein the training batch is from a data stream and the memory exemplars are from a reservoir of episodic memories.

10. The artificial intelligence system of claim 7, wherein the consistency loss is based on logits generated by the working model on the memory exemplars and replay logits chosen for the memory exemplars from the plastic model or the stable model.

11. The artificial intelligence system of claim 10, wherein the loss function is a weighted combination of the cross-entropy loss and the consistency loss, wherein the consistency loss is a mean squared error between logits generated by the working model on the memory exemplars and replay logits from the plastic model or the stable model.

12. The artificial intelligence system of claim 7, wherein parameters of the stable model and the plastic model are each updated using an exponentially weighted average of parameters of the working model with respective decay parameters at the first training rate and the second training rate, respectively.

13. A method for training an artificial intelligence inference model, comprising:
receiving a training batch from a data stream and memory exemplars from a reservoir of episodic memories;
updating a working model based on a loss function that enforces a consistency among the working model, a stable model and a plastic model on the memory exemplars, wherein the loss function includes a cross-entropy loss on a union of the training batch and the memory exemplars and a consistency loss on the memory exemplars;
updating the stable model and the plastic model based on the working model:
determining that the updated working model satisfy a training condition; and
providing the stable model, as the artificial intelligence inference model.

14. The method of claim 13, wherein the stable model is updated at a first training rate and the plastic model is updated at a second training rate, the first training rate being slower than the second training rate.

15. The method of claim 13, wherein the consistency loss is based on logits generated by the working model on the memory exemplars and replay logits chosen for the memory exemplars from the plastic model or the stable model.

16. The method of claim 15, wherein the memory exemplars include recent exemplars and older exemplars, wherein the replay logits for the recent exemplars are chosen from the plastic model and the replay logits for the older exemplars are chosen from the stable model.

17. The method of claim 13, wherein the updating the working model based on the loss function further comprises calculating a value of the loss function as a weighted combination of the cross-entropy loss and the consistency loss.

18. The method of claim 13, further comprising adding data from the training batch from the data stream to the reservoir of episodic memories.

19. The method of claim 13, wherein the updating the working model based on the loss function uses gradient descent with a learning rate parameter that controls a rate of the gradient descent.

20. The method of claim 14, wherein the updating the stable model and the plastic model is performed using an exponentially weighted average of the working model parameters with respective decay parameters corresponding to the respective first and second training rates.
